(19) United States
(12) Patent Application Publication
(10) Pub. No.: US 2004/0162774 A1
(43) Pub. Date: Aug. 19, 2004

(54) Financial instrument

(76) Inventor: Christopher Marie Paul John Golden, (US)

Correspondence Address: James V. Mahon, Esq., Clifford Chance US LLP, 200 Park Avenue, New York, NY, 10016, US

(21) Appl. No.: 10/366,580

(22) Filed: Feb. 13, 2003

(51) Int. Cl. G06F 17/60

(52) U.S. Cl. 705/36; 705/35

(57) ABSTRACT

A debt instrument structured as a plurality (N) of strips (S). Each of the strips includes a zero coupon instrument having a different maturity date and a talon (T). The talon represents future payments due subsequent to the maturation date of a last-maturing one of the of strips. The aggregate value of the strips at maturation plus the value of the talon equals an outstanding value. The product is structured such that upon maturation of each strip, the strip's value becomes due to a holder of the strip, a current amount of the outstanding value is reduced by the maturing strip's value yielding a new amount of the outstanding value, and a new strip is generated by stripping the talon. The new strip has a value that is determined based on the talon value, and the talon value is reduced after the stripping by the value of the new strip.

### BACKGROUND OF THE INVENTION

Large borrowers, such as multilateral development banks, often borrow money through the issue of bonds. These borrowers may issue numerous different bonds in the same currency. This may be done for a number of reasons. For example, they may want to borrow in different maturities in order to tap different types of lender. Another reason is to improve asset/liability matching.

To minimize the number of issues outstanding for any issuance program, an issuer may choose to issue fungible bonds. Typically this involves issuing a particular bond a first time, and the issuing further tranches of the same bond over time. However, if the bonds thus issued have a final maturity date, sometime soon after the initial issue, it becomes impractical to issue further tranches. As a result, a new bond is issued and the process is repeated.

There are three main reasons why typical bonds cannot be tapped in a commercially practical manner for any prolonged period: (i) bonds with a maturity date can only be tapped until they mature, (ii) the remaining life of a typical bond being tapped will always be shortening, so that the issuer tapping what was originally a ten-year bond two years after that bond was issued would only be tapping an eight-year bond, and (iii) as bonds age, and as their remaining lives move away from the typical benchmark maturities favored by investors, they become less liquid and often yield relatively more than benchmark bonds. Borrowers therefore prefer to issue bonds with benchmark maturities. As a result, the way in which borrowers may currently structure bond issues so as to make them susceptible to re-opening or “tapping” over long periods of time is to issue some form of perpetual bond (“perpetuals”). A perpetual bond is one which never has to fully repay its principal. That is, it has no fixed final maturity or final payment date.

Perpetuals can be tapped forever because they have no maturity date, and are therefore always in existence and tappable. However, they are not necessarily liquid, and because they have no maturity date, they cannot have a benchmark maturity. Furthermore the form of perpetuals is typically limited to fixed-rate perpetuals and floating-rate perpetuals. Fixed-rate perpetuals pay a fixed coupon as interest regularly, but never repay the principal. Fixed-rate perpetuals exist in a number of markets, most notably the in the UK government bond market. Floating-rate perpetuals pay interest at a fixed percentage spread to some index, usually based on short-term deposit interest rates. Floating-rate perpetuals are typically issued by banks and are treated by regulators as capital.

Conventional fixed-rate and floating-rate perpetual borrowing bond forms are relatively inflexible. This is due, in part, to the fact that the cashflow profile of their repayment streams is rigid. In the case of fixed-rate perpetuals, that cashflow profile is constant. In the case of floating-rate perpetuals, the floating-rate payments are not constant; however, their very volatility makes them unsuitable for may borrowers, particularly those who would prefer to know in advance what their payment streams will be far in the future. Neither form of debt is particularly appropriate for many bond issuers, and, although both of these structures exist, they are rarely issued, and they are rarely if ever “tapped”.

Furthermore, there are severe impediments to applying certain financial procedures, such as coupon stripping, to perpetual bonds. Coupon stripping is a well-accepted practice of buying a financial instrument, such as a coupon-bearing bond, and selling each payment separately as a zero coupon bond. Fixed term bonds and other fixed term instruments, such as U.S. treasuries, have been offered in a stripped form. Thus, for example, an issuer may offer investors a stripped U.S. 30 year treasury consisting of 60 coupons and 1 principal at the end (entire issue stripped). However, in the case of a perpetual bond, such as a U.K. government bond or gilt, conventional stripping procedures would result in an infinite number of coupons. As a result, it would be difficult to issue a stripped perpetual bonds using conventional stripping procedures.

### SUMMARY OF THE INVENTION

An innovative strippable bond is disclosed (the “Bond”). The Bond is structured as a debt instrument having a number of unique features. Generally speaking, the Bond has no coupon and no fixed maturity date. Further, for any issue, there are two key terms: the nominal outstanding and the proportion regularly redeemed. The structure is therefore that of an exponentially amortizing zero coupon bond with a negative exponent.

As a result of the Bond's unique structure, the weighted average life of the issue on any payment date is constant (in contrast to a conventional bond which declines inexorably over time). Further, since only a single key Bond parameter changes over time (i.e., the outstanding nominal amount), while other key parameters remain fixed (such as the average weighted life and the redemption rate ), outstanding issues of the Bond may be re-opened in a simplified manner. New tranches can be easily tapped into market demand at the current market price without requiring issuance of a new prospectus. Further, the terms and conditions of the new tranches can be the same as those of the original issue (apart from the issue price), whether current yields are, e.g., at 2% or at 22%. At the same time, by concentrating any specific maturity into only one issue, the structure maximizes the liquidity of the bonds issued.

Since the life of the Bond remains constant, and reopening issues is possible, a liability manager can minimize the number of different issues required to maintain a regular issuance program. For example, because its maturity never reduces, there only needs to be one “ten-year” issue, and that issue can be the natural vehicle for subsequent ten-year issuances. As a result, the issue can always be “on the run.” Of course with only one “ten-year” issue, any subsequent issuance should increase the total size of the issue outstanding. The combination of a permanently on-the-run issue that is consistently increasing in size can operate to increase the liquidity of the issue. These features can reduce issuance costs by reducing administration costs and/or by introducing an additional liquidity premium. A continuous program of Bond issuance in a single maturity can lead to a large, permanently on-the-run issue.

The Bond's structure can provide asset managers with a source of long-dated assets suitable for matching to long-dated liabilities (such as retirement annuities). Such long-dated assets are not easily available from other currently issued bond structures. For example, examining the shape of the UK Gilt market curve indicates that the demand for such assets far exceeds their supply. In the US, the recent announcement curtailing issuance of the 30-year long bond is leading to a similar search for such long-dated assets.

The Bond provides fund managers with the ability to maintain the average life of their portfolio in line with that of any relevant benchmarks. Another advantage that the Bonds have is that their cashflow structure closely matches that of a typical full-maturity index. In other words an asset manager can match between 70% and 85% of the cashflows in their benchmark index using, e.g., two different maturities of Bond issues. The accuracy of the fit can usually easily be increased if the Bond positions can be stripped.

Although an arbitrage-free method of pricing the Bond is to consider it as a series of zero-coupon bonds, historical analysis suggests that the implied internal rate of return (IRR) of the Bond would closely track the yield of a normal bullet bond with a final maturity equal to the Bond's average life. In contrast to the yield to maturity of a normal bond, the IRR of the Bond can be calculated from its price using the following simple formula:

$$y = \frac{r ( 1 - P )}{P}$$

In this formula, y is the yield, P is the price and r the repayment rate of the Bond. As a result, the Bond can be more easily traded on a straightforward price/yield basis, with the added advantage that the relationship between price and yield is much more straightforward than for “plain vanilla” bullet bonds.

Implementations may have one or more of the following advantages. The Bond is structured in a manner that increases fungibility of the instrument such that a benchmark issue with a substantially constant weighted average life can be maintained and that issue will never be “off-the-run”. These features can be used to maximize the liquidity of any issuance program while minimizing the number of different issues outstanding for any issuance program (even where that program takes place over a long time period). This allows investors to conveniently match a typical bond index. The Bond can enhance a investment portfolio's core liquidity and can provide a simple manner in which a structured exposure to the Bond's entire yield curve is provided. The Bond can be issued with different cashflow profiles which allows for better asset/liability management by issuers (and also investors). If a program of issuance ceases, outstanding Bonds will eventually mature. The Bonds are strippable and reconstitutable, allowing greater scope for their use within bond portfolios. A frequent borrower issuing the Bond can achieve different repayment stream cashflow profiles. This allows the borrower to achieve a more optimal asset/liability structure.

The details of one or more embodiments of the invention are set forth in the accompanying drawings and the description below. Other features, objects, and advantages of the invention will be apparent from the description and drawings, and from the claims.

### DESCRIPTION OF THE DRAWINGS

FIGS. 1 and 2 show cashflows resulting from different implementations of a financial product.

### DETAILED DESCRIPTION OF THE INVENTION

The Bond is a debt instrument that does not have a fixed maturity date but which, nonetheless, can be stripped into a number (N) of single cashflows (strips S₁ . . . S_{N}) and a residual strip (the “talon”, T). In a typical implementation, the number of strips remains constant at N until such time as a payment amount of a new strip is calculated to fall below a termination value. Each of the N strips is a zero-coupon bond, maturing in whole on its maturity date (typically the strip maturing dates are set one year apart). The talon represents all of the cashflows due after the last-maturing strip matures. Thus, at issuance, the outstanding value of the Bond, Vᵢₙᵢₜᵢₐₗ, is equal to the aggregate value of the N strips at maturation plus the value of the talon. The Bond is structured such that, upon maturation of each one of the strips, the maturing strip's value becomes due to a holder of the maturing strip (as a result of which, the current outstanding value is reduced by the maturing strip's value yielding a new amount of the outstanding value). In addition, a new strip is generated by stripping the talon. The new strip has a value that is determined based on the current talon value, and the talon value is reduced after production of the new strip.

In a typical implementation, each of the strips is assigned an ISIN code and the talon is assigned a different ISIN code. This results in a manageable number of outstanding ISIN codes for the issue (i.e., N+1), and thus, trading of both the strips and the talon becomes practicable. Further, as new strips are issued from the talon, each new strip can be assigned a ISIN code. Of course, other tracking codes may also be used (e.g., CUSIP codes).

Generally speaking, the value of a first one of the strips, S₁, equals (Vᵢₙᵢₜᵢₐₗ)(R), where R is the amortization rate and Vᵢₙᵢₜᵢₐₗ is a nominal outstanding amount of the Bond at the time of issuance. For each successive strip, the value of the strip is calculated based on the outstanding nominal at the time that strip matures multiplied by the amortization rate. This can be computed as Vᵢₙᵢₜᵢₐₗ minus the value all previously maturing strips. Thus, the value of strip Sᵢ can also be calculated as

$$( {V}_{initial} - {\sum }_{j < i} {S}_{j} ) ( R ) where {\sum }_{j < i} {S}_{j}$$

is the value of all previously maturing strips Alternatively, this value of a strip Sᵢ may be calculated as Vᵢₙᵢₜᵢₐₗ (1−R)⁽ⁱ⁻¹⁾ R. Further, the aggregate outstanding value of the N strips after a first X of the strips has matured equals

$${\sum }_{i = X + 1}^{i = X + N} {S}_{i}$$

(here, the indices i=X through i=X+N represent the N outstanding strips ordered in accordance with their successive maturity dates).

The Bond is structured so that as each strip matures, the talon produces a new strip. As a result, the talon value is reduced by the amount of the new strip. Thus, for example, at issue, the Bond can be stripped into 40 separate strips, representing the first 40 cashflows of the Bond, and a talon representing all further cashflows from the 41^{st} onwards. When the first strip matures, there would remain 39 strips from the original stripping operation. At this point, the talon produces a new strip (representing what would have been the 41^{st} cashflow at the time of the stripping operation, but which now represents the 40^{th} cashflow since the first original strip has matured). The result of the creation of the new strip is that there are still 40 strips outstanding, representing the next 40 cashflows due from the Bond, and a talon, representing all further cashflows from the 41^{st} onwards.

Using a Bond with an amortization rate of 10% as an example. At issuance, we strip the Bond and receive 40 strips representing the next 40 cashflows we would have received from the Bond, plus a talon, representing all further cashflows from the 41^{st} onwards. When the first of the 40 strips matures, the talon produces a new strip for 10% of the remaining nominal value, and that nominal value is thereby reduced by 10%. Using just the first six and last five strips and the talon for illustration, the first few years after stripping a £10,000,000 issuance of a 10% Bond on a payment date would lead to the following:

| | Upon initial | After year 1 | After Year | After Year |
|---|---|---|---|---|
| strip Maturity | stripping | stripping | 2 stripping | 3 stripping |
| 1-year | 1,000,000 | 900,000 | 810,000 | 729,000 |
| 2-year | 900,000 | 810,000 | 729,000 | 656,100 |
| 3-year | 810,000 | 729,000 | 656,100 | 590,490 |
| 4-year | 729,000 | 656,100 | 590,490 | 531,441 |
| 5-year | 656,100 | 590,490 | 531,441 | 478,296 |
| 6-year | 590,490 | 531,441 | 478,296 | 430,467 |
| . | . | . | . | . |
| . | . | . | . | . |
| . | . | . | . | . |
| 35-year | 27,813 | 25,031 | 22,528 | 20,276 |
| 36-year | 25,031 | 22,528 | 20,276 | 18,248 |
| 37-year | 22,528 | 20,276 | 18,248 | 16,423 |
| 38-year | 20,276 | 18,248 | 16,423 | 14,781 |
| 39-year | 18,248 | 16,423 | 14,781 | 13,303 |
| 40-year | 16,423 | 14,781 | 13,303 | 11,972 |
| TALON | 147,813 | 133,032 | 119,729 | 107,757 |
| Total Value | 10,000,000 | 9,000,000 | 8,100,000 | 7,290,000 |
| (strips + talon) | | | | |

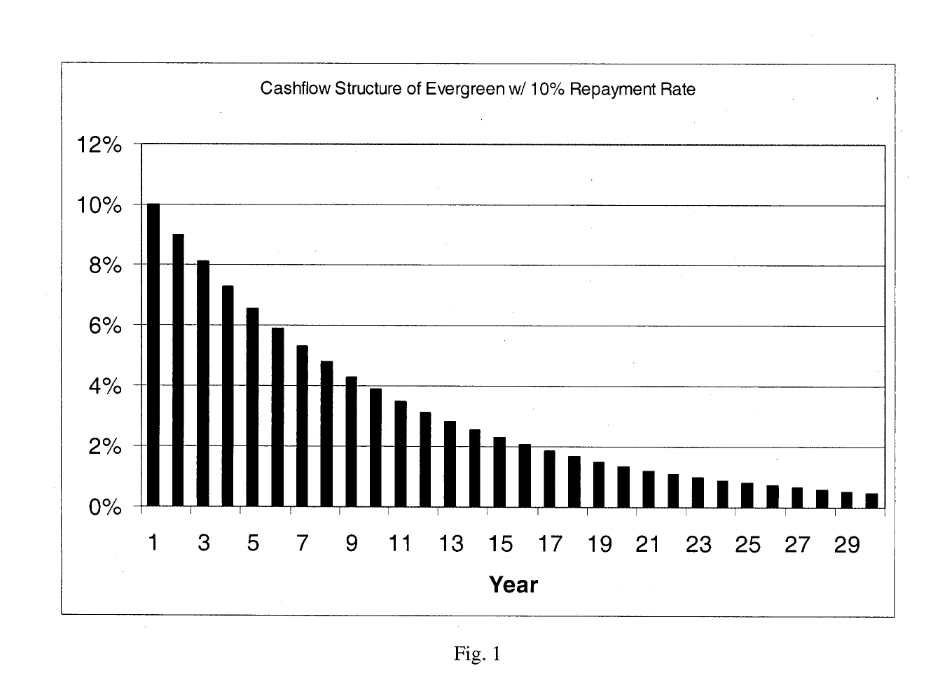

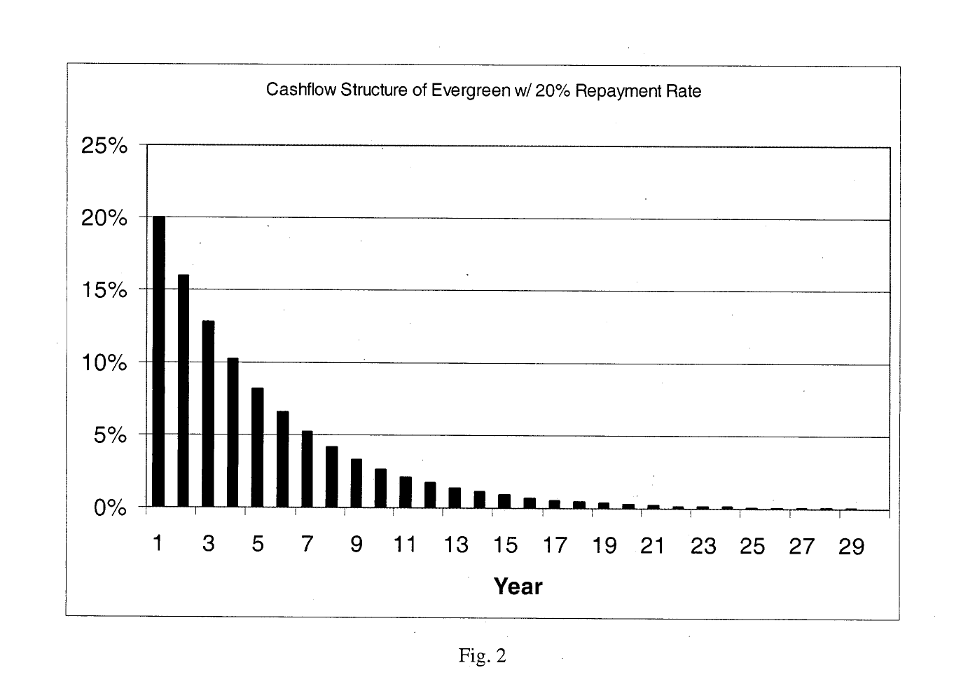

After one year the original 1-year strip of £1,000,000 matures. Upon the maturity of the first strip, the talon (which, immediately preceding the stripping, has a nominal value of £147,813) produces a new 40-year strip of £14,781 nominal value (which is 10% of the nominal value of the talon). Having produced that new strip, the talon reduces in size by 10%, to £133,032. The total nominal value of all strips plus the talon is reduced by the nominal value of the original 1-year strip that matured, which amounted to £1,000,000 or 10% of the original amount stripped. Moreover there are still 40 strips and one talon outstanding. This is further illustrated in FIG. 1 which shows the cashflow of a 10% Bond over time relative to its initial nominal value. For comparison purposes, FIG. 2 shows the cashflow of a 20% Bond over time relative to its initial nominal value.

Generally speaking, an issuer of the Bond may want to issue forever. However, for an investor, this may not be true due to the fact that, at some point, the principal outstanding becomes so small it is virtually invisible. Consequently, the Bond can be structured to include a termination condition which, when reached, prevents further stripping of the talon (and, in some implementations, also results in extinguishing of the talon value). The termination condition can be set to the time when a payment amount of a generated new strip is calculated to fall below a termination value. For example, if the next payment drops below a fixed number (e.g., $1), then the holding is extinguished.

The stripping of the bond allows different market participants to value different parts of the Bond's maturity structure differently. Thus a pension fund might be more interested in owning the longer-dated cashflows than the shorter-dated ones, whereas a money-market fund would be most interested in the first (and possibly the second) cashflow. Making the Bond strippable allows the market greater flexibility to exploit their original features.

It is noted that past efforts at stripping perpetual bonds resulted in a bond having a fixed number of coupons and a tail portion representing right to new bond and did not create a new security (i.e., a security with a new ISIN) upon maturation of a coupon. This is different from the Bond which has a talon represents right to future cash flows, rather than the right to a new bond, and which creates a new security with a new ISIN (International Security Identification Number). Thus, if you own a talon on the date before the payment date, then on the payment date the talon worth is reduced and you now own a new security. The procedure for handling the Bond improves fungibility of the talon because each talon can be uniquely tracked through its ISIN number

The weighted average life of the Bond can be calculated as the reciprocal of the constant percentage redeemed each year. So the Bond, in the foregoing example, has a weighted average life of 10 years (i.e., 1/0.10). Similarly, a Bond redeeming 4% per annum would have a weighted average life of (1/0.04)=25 years. Thus in the example of the 10% Bond given above, the weighted average life of the Bond on every payment date is 10 years, regardless of the date of initial issuance. In contrast, a conventional bond has a declining average life on each payment date.

The Bonds include a mechanism for achieving different cashflow profiles. This mechanism is the “repayment rate” of the Bond. The repayment rate is the rate at which the nominal borrowed which is still outstanding will be repaid. The repayment rate is set at the outset of an new issue of the Bond. A borrower can issue the Bond with different repayment rates. (Each one of these can be tapped as often as desired in the future.) Every different repayment rate has a different repayment profile.

Mechanisms can be incorporated into the structure of the Bond to allow the issuer to retire bonds if the issuer terminates the program. For example, if the issuer stops issuing, there comes a point where the Bond simply becomes extinguished. This is achieved by either redeeming or extinguishing Bonds remaining in any holding which is too small to receive a principal repayment. Another mechanism is that the issue can be callable in whole or in part at any time at 100. Since the Bond will typically be issued at a significant discount to 100, this is onerous to the borrower. Nevertheless it does mean that a borrower who does not want to wait for holdings to be extinguished over time, and who has exhausted other possible means of doing so (such as buying bonds in the market, or exchanging bonds for different issues), has a method of retiring outstanding bonds from a defunct program. The Bond is designed to be issued within a program of issuance. The structure of the Bond is such that its advantages are optimized if it is used as a vehicle for frequent borrowings. The structure is unique in that if a borrower desires to do so it can issue the same bond (i.e., a Bond with a unique ISIN number or other unique security identifier) forever. The mechanism for achieving perpetual issuance through the fungibility of all bonds with the same repayment rate is to issue bonds which have the same payment date.

A number of embodiments of the present invention have been described. Nevertheless, it will be understood that various modifications may be made without departing from the spirit and scope of the invention. Accordingly, other embodiments are within the scope of the following claims.

What is claimed is:

1. A financial product comprising a debt instrument, the debt instrument comprising:
a plurality (N) of strips (S), each of the strips comprising a zero coupon instrument having a different maturity date; and
a talon (T), the talon representing future payments due subsequent to the maturation date of a last-maturing one of the plurality of strips;
wherein,
the aggregate value of the strips at maturation plus the value of the talon equals an outstanding value, and
the product is structured such that upon maturation of each one of the strips,
the maturing strip's value becomes due to a holder of the maturing strip,
a current amount of the outstanding value is reduced by the maturing strip's value yielding a new amount of the outstanding value, and
a new strip is generated by stripping the talon, said new strip having a value that is determined based on the current talon value, and said talon value being reduced after said stripping by the value of the new strip.

2. The product of claim 1 wherein the dept instrument comprises a structure enabling long-term duration of the financial product through the generation of new strips from the talon until such time as a payment amount of a generated new strip is calculated to fall below a termination value.

3. The product of claim 2 wherein the number of strips remains constant until such time as a payment amount of a generated new strip is calculated to fall below a termination value.

4. The product of claim 1 comprising a financial structure whereby, at an issue date, the aggregate value of the N strips (S₁ . . . S_{N}) and the talon (T) equals an initial outstanding value (Vᵢₙᵢₜᵢₐₗ)

5. The product of claim 4 wherein:
the aggregate value of the N strips equals
$${\sum }_{i = X + 1}^{i = X + N} {S}_{i}$$
where X represents the number of strips that have matured and the indices i=X+1 through i=X+N represent an ordering of the N outstanding strips based on their successive maturity dates.

6. The product of claim 5 wherein:
the value of a first maturing one of the strips, S₁,equals (Vᵢₙᵢₜᵢₐₗ₎ (R), where R is the amortization rate and Vᵢₙᵢₜᵢₐₗ is a nominal outstanding amount of the product at the time of issuance.

7. The product of claim 6 where the value of an i^{th} maturing strip Sᵢ equals
$$( {V}_{initial} - {\sum }_{j < i} {S}_{j} ) ( R ) for i > 1.$$

8. The product of claim 6 comprising a financial structure whereby the value of a strip Sᵢ equals Vᵢₙᵢₜᵢₐₗ(1−R)⁽ⁱ⁻¹⁾ R for i≧1.

9. A method of debt issuance comprising:
stripping a debt instrument into a plurality (N) of strips (S), each of the strips comprising a zero coupon instrument having a different maturity date and a talon (T), the talon representing future payments due subsequent to the maturation date of a last-maturing one of the plurality of strips, and wherein, the aggregate value of the strips at maturation plus the value of the talon equals an outstanding value; and
upon maturation of each one of the strips, generating a new strip by stripping the talon, said new strip having a value that is determined based on the current talon value, and said talon value being reduced after said stripping by the value of the new strip.

10. The method of claim 9 wherein the instrument is structured such that upon maturation of a strip, the maturing strip's value becomes due to a holder of said maturing strip and a current amount of the outstanding value is reduced by the maturing strip's value yielding a new amount of the outstanding value.

11. The method of claim 9 further comprising inhibiting the generation of new strips from the talon when a payment amount of a generated new strip is calculated to fall below a termination value.

12. The method of claim 9 wherein:
at an issue date, the aggregate value of the N strips (S₁ . . . S_{N}) and the talon (T) equals an initial outstanding value (Vᵢₙᵢₜᵢₐₗ).

13. The method of claim 12 wherein:
the aggregate value of the N strips equals
$${\sum }_{i = X + 1}^{i = X + N} {S}_{i}$$
where X represents the number of strips that have matured and the indices i=X+1 through i=X+N represent an ordering of the N outstanding strips based on their successive maturity dates.

14. The method of claim 12 wherein:
the value of a first maturing one of the strips, S₁,equals (Vᵢₙᵢₜᵢₐₗ₎ (R), where R is the amortization rate and Vᵢₙᵢₜᵢₐₗ is a nominal outstanding amount of the product at the time of issuance.

15. The product of claim 13 where the value of an i^{th} maturing strip Sᵢ equals
$$( {V}_{initial} - {\sum }_{j < i} {S}_{j} ) ( R ) for i > 1.$$

16. The product of claim 13 comprising a financial structure whereby the value of a strip Sᵢ equals Vᵢₙᵢₜᵢₐₗ(1−R)⁽ⁱ⁻¹⁾ R for i≧1.

17. A method of debt instrument issuance comprising:
means for stripping a debt instrument into a plurality (N) of strips (S), each of the strips comprising a zero coupon instrument having a different maturity date;
means for forming a talon for the debt instrument, the talon representing future payments due subsequent to the maturation date of a last-maturing one of the plurality of strips; and
means for generating new strips from the talon upon the maturation of ones of the strips.

18. A debt instrument comprising:
a nominal outstanding; and
a recurring payment, said payment being computed at each payment time based on the nominal outstanding; and wherein:
the payment is periodic until a payment threshold has been reached;
the nominal outstanding is reduced at each of said payments by an amount of said payment;
the payment comprises a cashflow that diminishes over time in accordance with the reduction in the nominal outstanding; and
a slope of said cashflow is adjustable at time of issuance of the debt instrument based on a selected repayment rate.

19. The instrument of claim 18 wherein computing based on the nominal outstanding comprises computing as a fixed percentage of the nominal outstanding.

20. The instrument of claim 18 wherein computing based on the nominal outstanding comprises computing based a formula linked to inflation.
